(19) United States
(12) Patent Application Publication
(10) Pub. No.: US 2025/0011682 A1
(43) Pub. Date: Jan. 9, 2025

(54) COLORED PLANAR WICK

(71) Applicant: LUMETIQUE, INC., Irvine, CA (US)

(72) Inventor: DayNa DECKER, Irvine, CA (US)

(73) Assignee: LUMETIQUE, INC., Irvine, CA (US)

(21) Appl. No.: 18/712,274

(22) PCT Filed: Nov. 22, 2022
(86) PCT No.: PCT/US2022/050654

§ 371 Date: May 22, 2024

Related U.S. Application Data
(60) Provisional application No. 63/281,797, filed on Nov. 22, 2021.

(51) Int. Cl. C11C 5/00

(52) U.S. Cl. CPC C11C 5/006

(57) ABSTRACT

Colored wicks include a sheet including at least one of wood, a wood-like substance, and cellulose fiber, wherein the sheet is treated with a dye or color pigment. Processes for preparing a colored planar wick, include: pretreating a sheet of wick material: dyeing the pretreated sheet of wick material: pressing the dyed sheet of wick material; and cutting the pressed sheet of wick material to obtain the colored planar wick. Colored planar wicks may exhibit improved burning temperature, flame height, greater wax pool growth, and acoustic properties relative to undyed wicks.

### BACKGROUND OF THE DISCLOSURE

### Technical Field

The present disclosure relates to colored planar wicks for use in candles and other lighting devices, candles and other lighting devices employing such wicks, and methods of preparing such wicks, candles, and other lighting devices.

### Description of the Related Art

The “background” description provided herein is for the purpose of generally presenting the context of the disclosure. Work of the presently named inventor, to the extent it is described in this background section, as well as aspects of the description which may not otherwise qualify as prior art at the time of filing, are neither expressly or impliedly admitted as prior art against the present disclosure.

A candle may include an ignitable wick embedded in wax or another flammable solid substance such as tallow that provides light, and in some cases, a fragrance. A candle may also be used to provide heat or keep time. A candle wick is typically made of braided cotton that holds the flame of the candle. A candle wick works by capillary action, conveying (or “wicking”) molten fuel to the flame. When a molten fuel such as melted wax reaches the flame the fuel vaporizes and combusts. A candle wick influences how a candle burns. Important characteristics of a candle wick include diameter, stiffness, fire-resistance, and tethering.

Candles may present safety issues, particularly with respect to causing fires and burning users. In view of these issues, efforts have been made to test various aspects of the manner in which candles burn including, for example, stability, burn time, abnormalities, smoke/flaring, sputter, overflow, re-ignition, flame height, afterglow, external surface temperature (thermocouple), direct flame impingement, pool temperature, pool uniformity, pool diameter, carbon deposit, and soot emissions. These parameters contribute not only to the safety of a candle, but also to the performance and aesthetic characteristics of a candle.

Candle wicks have been woven or braided for well over the last century. Such conventional wicks may be woven from multiple fibers or filamentary yarns. The most commonly used yarn is cotton, although other natural fibers such as rayon, nylon, and hemp have also been used. Braided wicks may be produced in various sizes, shapes and constructions to achieve desired performance (flame height, wax pool size, self-trimming) and process (stability, self-supporting) requirements. The appropriate wick selection for a particular candle includes type of weave, core, size (diameter or width), and density of a wick. Even if wick selection is confined to braided wicks, there are many different types of braided wicks from which to choose.

More recent developments in candle design and manufacture involve the use of a planar wick in a candle. Such planar wicks may be made of wood, wood-like materials, semi-wood materials, cellulose materials, and other more rigid materials. Such planar wicks may provide improved capillary flow and increased functional surface area relative to prior braided wicks. As a result, such planar wicks can burn efficiently in a candle without producing undesirable smoke and carbon heading. Further, such planar wicks can create a stable and uniform wax pool diameter. By virtue of the materials and shapes of such planar wicks, the physical shape of a flame may be different than in candles using prior braided wicks. Also, such planar wicks offer decorative possibilities not available with prior braided wicks and may produce sound when burned—for example, a crackling sound like the sound of wood burning in a fireplace. Such planar wicks and candles employing them are described, for example, in U.S. Pat. Nos. 9,410,696, 9,261,275, U.S. D740,461, U.S. Pat. Nos. 9,039,409, 8,961,171, U.S. D705,459, U.S. D678,558, U.S. Pat. No. 8,348,662, U.S. D644,360, U.S. D644,359, U.S. D643,554, US 2016/0298837, US 2012/0225392, US 2011/0027737, US 2011/0027736, US 2011/0027735, US 2011/0024945, US 2005/0037308, and US 2004/0009447. The disclosures of each of the foregoing patents and patent application publications are incorporated herein by reference in their entireties.

A subsequent variation on such planar wicks is a wooden wick including a strip of wood, a booster member, which may also be made of wood, and a means for adhering the booster member to such strip of wood. Such planar wicks and candles employing them are described, for example, in U.S. Pat. Nos. 9,796,946, 9,388,365, 9,120,995, U.S. D715,989, U.S. D708,777, U.S. Pat. No. 8,708,694, U.S. D669,615, U.S. D663,450, US 2016/0272923, US 2015/0322379, US 2012/0064467, and US 2008/0153046. The disclosures of each of the foregoing patents and patent application publications are incorporated herein by reference in their entireties.

A further variation on planar wicks is a planar wick including a strip of wood, a booster member, which may also be made of wood, and a means for adhering the booster member to such strip of wood, wherein at least one of the strip of wood and booster is composed of wood having a figured grain. Such planar wicks and candles employing them are described, for example, in U.S. Pat. No. 9,816,053 and US 2016/0281031. The disclosures of the foregoing patent and patent application publication are incorporated herein by reference in their entireties.

A further variation on planar wicks is a planar wick including a planar body, wherein wood shavings are adhered to at least one side of the planar body. Such planar wicks and candles employing them are described, for example, in US 2016/0272922. The disclosure of the foregoing patent application publication is incorporated herein by reference in its entirety.

A further variation on planar wicks is a planar wick including a planar body, wherein the wick is modified by cutting, engraving, printing, dyeing, etc., to achieve improvements in safety, performance, and aesthetic characteristics of the wick and a candle employing such wick. Such planar wicks and candles employing them are described, for example, in US 2021/0033278. The disclosure of the foregoing patent application publication is incorporated herein by reference in its entirety.

While the foregoing planar wicks and subsequent variations represent a leap forward in design relative to the preceding braided wicks, there remains a need for improvements in safety, performance, and aesthetic characteristics of candle wicks and candles employing such wicks.

In view of the foregoing, an object of the present disclosure is to provide colored planar wicks for use in candles and other lighting devices, candles and other lighting devices employing such wicks, and methods of preparing such wicks, candles, and other lighting devices, with advantageous properties.

### BRIEF SUMMARY OF THE DISCLOSURE

According to a first aspect, the present disclosure relates to a colored wick, including: a sheet including at least one selected from wood, a wood-like substance, and cellulose fiber. The sheet is treated with a dye or color pigment, the sheet is laser cut to form interlocking sheets, and the colored wick comprises at least two interlocking sheets assembled together to form an X-shape or +-shape when viewed from above when provided in a candle.

According to a second aspect, the present disclosure relates to a candle, including: a colored wick; and a body of meltable fuel. The colored wick includes a sheet including at least one of wood, a wood-like substance, and cellulose fiber, the sheet is treated with a dye or color pigment, the sheet is treated with at least one of hot pressure and cold pressure, the sheet is laser cut to form interlocking sheets, and the sheet is laser cut into at least two interlocking sheets assembled together to form an X-shape or +-shape when viewed from above.

According to a third aspect, the present disclosure relates to a colored wick, including: a sheet including at least one of wood, a wood-like substance, and cellulose fiber. The sheet is treated with a dye or color pigment, the sheet is laser cut, and the sheet is shaped to have an S-shape, a curve, or a round shape when viewed from above when provided in a candle.

According to a fourth aspect, the present disclosure relates to a candle, including: a colored wick; and a body of meltable fuel. The colored wick includes a sheet comprising at least one selected from wood, a wood-like substance, and cellulose fiber, the sheet is treated with a dye or color pigment, the sheet is treated with at least one of hot pressure and cold pressure, and the sheet is laser cut and shaped to have an S-shape, a curve, or a round shape when viewed from above.

According to a fifth aspect, the present disclosure relates to a process for preparing a colored planar wick, including: pretreating a sheet of wick material; dyeing the pretreated sheet of wick material; pressing the dyed sheet of wick material; and cutting the pressed sheet of wick material to obtain the colored planar wick.

According to a sixth aspect, the present disclosure relates to a colored planar wick obtained by a process as described herein.

According to a seventh aspect, the present disclosure relates to a candle, including: a colored planar wick as described herein; and a body of meltable fuel.

According to an eighth aspect, the present disclosure relates to a process for preparing a colored planar wick, including: cutting a sheet of dyed wick material to obtain the colored planar wick; wherein the sheet of wick material was prepared by a process including: pretreating a sheet of wick material; dyeing the pretreated sheet of wick material; and pressing the dyed sheet of wick material.

According to a ninth aspect, the present disclosure relates to a colored planar wick, including: a planar member including a wick material; and a dye impregnated into the wick material; wherein: the dye is present through an entirety of a thickness of the wick material; the wick exhibits an improved burning parameter relative to an undyed wick formed of the same material and having the same dimensions, when the wick and the undyed wick are evaluated by burning in candles having identical structure and composition; and the improved burning parameter is at least one selected from the group consisting of higher burning temperature, higher flame height, wider wax pool, and reduced acoustic crackling.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1(a) is a perspective view of a first embodiment of an exemplary colored planar wick according to the present disclosure;

FIG. 1(b) is a front view of a first embodiment of an exemplary colored planar wick according to the present disclosure;

FIG. 1(c) is a top view of a first embodiment of an exemplary colored planar wick according to the present disclosure;

FIG. 2 is a perspective view of a first embodiment of an exemplary colored planar wick according to the present invention provided in a disclosure;

FIG. 3(a) is a perspective view of a second embodiment of an exemplary colored planar wick according to the present disclosure;

FIG. 3(b) is a front view of a second embodiment of an exemplary colored planar wick according to the present disclosure;

FIG. 3(c) is a top view of a second embodiment of an exemplary colored planar wick according to the present disclosure; and

FIG. 4 is a perspective view of a second embodiment of an exemplary colored planar wick according to the present disclosure provided in a candle.

### DETAILED DESCRIPTION OF THE EMBODIMENTS

Embodiments of the present disclosure will now be described more fully hereinafter with reference to the accompanying drawings, in which some, but not all of the embodiments of the disclosure are shown.

As used herein, the words “a” and “an” and the like carry the meaning of “one or more.” Additionally, within the description of this disclosure, where a numerical limit or range is stated, the endpoints are included unless stated otherwise. Also, all values and subranges within a numerical limit or range, including subranges excluding endpoints, are specifically included as if explicitly written out.

As used herein, the terms “optional” or “optionally” mean that the subsequently described event(s) can or cannot occur or the subsequently described component(s) may or may not be present (e.g., 0 wt %).

The term “comprising” is an open-ended term synonymous with terms such as including, containing, or having and is used herein to claim aspects of the invention which may include additional steps, components, functionality, and/or structure. The term “consisting essentially of” is used herein to claim aspects of the invention and additional unrecited steps or components that would not have a material effect on the basic and novel properties of a colored wick, candle, or other lighting device according to the present disclosure—as claimed or as obtained by a claimed process. Basic and novel properties of the present disclosure include the capability of a colored planar wick to produce a taller flame height, a wider wax pool, a lower crackling sound, and/or greater consistency in the foregoing properties from wick-to-wick, relative to known planar wicks. The term “consisting of” is used to claim aspects of the invention in which only those features explicitly recited in a claim are included and thus other steps or components not explicitly or inherently included in the claim are excluded.

The following discussion is made with reference to colored planar wicks and candles including such wicks. However, the colored planar wicks of the present application may also be used in other lighting devices, particularly in lanterns or lamps using a fuel that is liquid rather than solid at room temperature. In such embodiments, the composition and structure of the colored planar wicks described below may be modified to ensure that a safe, sustained flame is obtained when the colored planar wick is lit.

In various exemplary embodiments, the present disclosure relates to colored planar wicks for use in candles, candles employing such wicks, and methods of preparing such wicks and candles.

It is expressly intended that the features of the various planar colored wicks and candles described herein be interchangeably used and used in combination. That is, to the extent that a material, structure, and/or size is mentioned with respect to an embodiment, it is expressly intended that such parameter be suitably substituted for use in other embodiments. The present inventor has contemplated such combinations and intends that they be encompassed by this disclosure even if not written out.

In embodiments, a candle includes a body of meltable fuel and a colored planar wick. Meltable fuels are materials that are solid at room temperature and provide light when vaporized and ignited (i.e., when conveyed via a lit wick embedded in a body of the meltable fuel). Exemplary meltable fuels include fusible, flammable solid waxes and wax-like materials such as, for example, petroleum (paraffin) wax, mineral (montan) wax, synthetic wax (polyethylene or Fischer Tropsch), natural waxes (vegetable or animal—e.g., beeswax, carnauba, candelilla, soy, coconut, palm, apricot), microcrystalline waxes, polymers, polyolesters, clear candle waxes or gels (ester-terminated polyamides (ETPA) or ETPA-based materials), and other fuels known to skilled artisans. A single meltable fuel or blends of meltable fuels may be used.

In embodiments, meltable fuels may be modified with additives to alter the hardness, color, burn rate, and/or aroma of the meltable fuel. Exemplary additives include stearic acid, UV inhibitors, polyethylene, scent oils, and colorants, such as pigments and/or dyes.

In embodiments, a candle includes a free-standing body of meltable fuel. The shape of the free-standing body of meltable fuel is not particularly limited--any shape that can be suitably molded would be acceptable.

In alternative embodiments, a candle includes a meltable fuel held in a container. There is no particular limitation on the size or shape of the container or the material from which the container is made. In embodiments, the container is made of glass, ceramic, metal, concrete, or plastic. The glass, ceramic, metal, concrete, or plastic may be natural, clear, or colored. In embodiments, the container is a resealable jar. In embodiments, the container is in the shape of a cylinder or prism open at a top end. The cylinder may be a right, oblique, or irregular cylinder having a circular, oval, or other cross-section. The prism may be a right, oblique, or irregular prism having a triangular, square, rectangular, or other polygonal cross-section.

Whether provided as freestanding bodies of meltable fuel or in containers, candles generally can be defined in terms of their width and height as configured when in use. Candles as described herein may have a width of up to 1 inch, 1 inch, 2 inches, 3 inches, 4 inches, 5 inches, 6 inches, 7 inches, 8 inches, 9 inches, 10 inches, 10 inches or more, and all subranges in tenths and hundredths of an inch therein. Preferably candles have a width of 1 to 10 inches. Candles may have a height of up to 2 inches, 2 inches, 3 inches, 4 inches, 5 inches, 6 inches, 7 inches, 8 inches, 9 inches, 10 inches, 10 inches or more, and all subranges in tenths and hundredths of an inch therein. Preferably candles have a height of 2 to 10 inches.

In embodiments, the material and dimensions of a colored planar wick are selected to promote the candle's functionality as well as the candle's contributions to ambiance. In embodiments, the wick is made of wood, semi-wood or wood-like material and, when lit, provides a pleasant crackling sound and burns more thoroughly with less carbon heading and sooting than conventional wicks. Processed wood materials such as particleboard and fiberboard may also be used. Overall, woods having relatively straight, condensed grains and without checking make effective wicks. In contrast to traditional wicks, which require periodic trimming, maintenance of planar colored wicks can be performed with or without any tools. Rather, burned edges of planar colored wicks can be removed with the user's fingers before relighting. In various exemplary embodiments, such wicks are formed of single-ply, double-ply, multi-ply, multi-fibrous, colored, printed, die cut, and/or laser cut materials. Alternatively or in addition, embedded minerals, oils, or oxidation enhancers may be used.

In embodiments, woods such as poplar, cherry, maple, wenge, oak, rosewood, and bamboo may be used as materials for preparing colored wicks. Preferably heartwood is used. Hard non-brittle, tight grain woods are preferred. Certain species may be preferable in particular applications because its higher moisture or oil content may influence characteristics of the flame and/or other properties such as production of a desirable crackling sound when burning. In addition to the preferred woods mentioned above, others such as walnut, ash, birch, pearwood, sapele, pommele, zebrawood, lacewood, mahogany, pine, teak, ebony, and various burls, may be used as colored wick materials. Woods having various moisture contents may be used. Particularly, woods having moisture contents of up to 1%, 1%, 2%, 3%, 4%, 5%, 6%, 7%, 8%, 9%, 10%, 11%, 12%, 13%, 14%, 15%, 16%, 17%, 18%, 19%, 20%, 20% more, and all subranges therein in tenths and hundredths of a percent, may be used to form colored wicks as described herein.

Colored planar wicks including semi-wood or wood-like materials, either alone or in combination with wood, are particularly desirable. Layers or portions of wood may be combined, for example, with layers or portions of wood-like materials, semi-wood materials, cellulose, hemicellulose, lignin, cotton fiber, hemp fiber, coir, flax, and/or protein fibers. Alternatively, cellulose, hemicellulose, lignin, cotton fiber, hemp fiber, coir, flax, and/or protein fiber, can used to prepare colored wicks without the use of wood. Materials other than plain or pure wood, as described herein, may be used in any suitable format. For example, solid materials may be cut into sheets for further processing as described herein. As a further example, materials that are fibrous or particulate may be pressed into sheets for further processing as described herein with or without the use of adhesives or other matrix materials. Further, two, or three, or more sheets of material obtained as described herein or otherwise may be laminated together, e.g., using adhesives. Such laminates may include multiple layers of the same or different materials and layers having different dimensions.

Cotton or cotton-like materials, particularly, can be incorporated into a colored planar wick's construction. One example is to sandwich a piece of cotton between sheets of wood and seal the sandwiched construction with wax or an adhesive. Another example is to make a wood particle/powder fiberboard with small bits of cotton incorporated therein. A further example is to layer one or more layers of a cotton-like material to one or more layers of a wood-like material. The layers in such embodiments can be different or the same in width, height, and thickness.

While the wicks described herein are referred to as colored planar wicks, they need not be strictly or truly planar. Instead, it is expressly intended that the term planar-unless described as “strictly” or “truly” planar-includes bent or curved planar members or composites of multiple planar members. While a strictly or truly planar wick might have the shape of a straight line when viewed from above, a bent or curved planar wick might have the shape of a circle or an “S” when viewed from above. A wick including a composite of multiple planar members might have the shape an “X,” a “+,” or a cross from above. Thus, a colored planar wick as described herein may include bent, curved, or multiple, combined planar members that yield any alphanumeric or symbolic shape when viewed from above. Likewise, a sheet of material may be strictly or truly planar, bent or curved, or a composite of multiple sheets.

Colored planar wicks described herein and shown in figures attached hereto are generally planar or sheet-shaped or prepared from materials that planar or sheet-shaped. Such materials maybe further processed into precise shapes as described herein using techniques such as die cutting and laser cutting. Moreover, wicks can be cut through an entirety of their thickness or engraved through a portion of their thickness, e.g., by laser. Such cutting or engraving can be performed to add ornamental design (adding alphanumeric or symbolic shapes onto the surface or through the thickness of the wick) and/or to alter the function of a wick (e.g., by controlling flow of molten fuel through the wick).

Colored planar wicks described herein are intended to be used, e.g., in candles. When used in a candle, wicks are stood in a body of meltable fuel. Thus, wicks generally have a height dimension corresponding to the height dimension of a candle when the colored wick is in use. Likewise, wicks that are strictly or truly planar will have a width and a thickness that are perpendicular to the height, the thickness being the smallest dimension of the colored wick. Wicks that more generally planar (e.g., an “X” wick or a “+” wick) can be described by an overall greatest width in a direction perpendicular to the height and a thickness corresponding to the smallest dimension of the planar member that was bent, curved, or combined to obtain the wick.

Colored planar wicks described herein may have any suitable combination of dimensions and the dimensions of particular embodiments are selected to produce desired effects described herein in combination with particular materials and other structural parameters. Wicks may have a thickness of up to 0.005 inches, 0.005 inches, 0.010 inches, 0.020 inches, 0.030 inches, 0.040 inches, 0.050 inches, 0.060 inches, 0.070 inches, 0.080 inches, 0.090 inches, 0.1 inches, 0.11 inches, 0.12 inches, 0.125 inches, 0.125 inches or more, and all subranges in hundredths and thousandths of an inch therein. Preferably wicks have a thickness of 0.010 to 0.040 inches. Wicks may have a width of up to 0.0625 inches, 0.0625 inches, 0.125 inches, 0.25 inches, 0.375 inches, 0.5 inches, 1.0 inches, 1.5 inches, 2.0 inches, 2.5 inches, 3.0 inches, 3.5 inches, 4.0 inches, 4.5 inches, 5.0 inches, 5.5 inches, 6.0 inches, 6.5 inches, 7.0 inches, 7.5 inches, 8.0 inches, 8.5 inches, 9.0 inches, 9.0 inches or more, and all subranges in tenths of an inch therein. Preferably wicks have a width of 0.25 to 6 inches. Wicks may have a height of up to 1 inch, 1 inch, 2 inches, 3 inches, 4 inches, 5 inches, 6 inches, 7 inches, 8 inches, 9 inches, 10 inches, 10 inches or more, and all subranges in tenths of an inch therein. Preferably wicks have a height of 1 to 8 inches. Wick width and candle width may be described in ratios of their respective widths and ranges of ratios based on any of the width values described herein. Further, in embodiments, both wicks and candles will have variable widths. For example, both wick and candle may have widths that taper towards the top, taper towards the bottom, taper towards the middle, or taper at the top and the bottom. In preferred embodiments, the wick width varies with the candle width along the height dimension of the candle.

When lit, candles will create wax pools that vary in size based on the wax type and the colored wick type and configuration. In preferred embodiments, the wax should liquify to the outer portion of the candle and the flame height should be between 0.05 and 3.0 inches in height, including all subranges in tenths and hundredths of an inch therein.

In embodiments, candles can be made using containers or molds. In embodiments, a colored planar wick is positioned in a container or mold and a melted meltable fuel is added thereto. The colored wick can be positioned with or without a sustainer. A sustainer will include a flat surface or multiple points of contact on its bottom to stably hold a wick upright in the absence of meltable fuel and/or while melted fuel is poured around the wick. A sustainer will further include structure for holding a wick upright. For example, twin upright structures for grasping a generally planar or sheet like colored wick or a cup-like structure for holding a substantially cylindrical colored wick. In alternative embodiments the melted fuel can be added to the mold or container before positioning the wick.

In various exemplary embodiments, processes for preparing a colored planar wick according to the present disclosure, include: pretreating a sheet of wick material; dyeing the pretreated sheet of wick material; pressing the dyed sheet of wick material; and cutting the pressed sheet of wick material to obtain the colored planar wick. It is expressly contemplated that these steps and the variants described herein may be carried out in any workable sequence.

In further embodiments, processes may further include drying the dyed sheet of wick material before pressing. Drying may be carried out using a kiln, drying oven, or any other appropriate apparatus, or alternatively air drying can be performed. In still further embodiments, processes may include applying a substance to the wick material after dyeing and before pressing. Suitable substances include waxes and oils.

In various exemplary embodiments, pretreating the sheet of wick material includes bleaching the sheet of wick material. Bleaching may be carried out using any suitable technique. Exemplary bleaching media include chlorine, two-part wood bleach, oxalic acid, and peroxide. Bleaching can be carried out in any suitable manner, including application by spray, immersion, etc. Desirably, the result of bleaching will cause the wick material will be cleaned and lightened in color. In some cases, wood can be rendered nearly white by the bleaching process.

In various exemplary embodiments, the sheet of wick material is a sheet of wood, i.e., wood veneer. The sheet of wick material may desirably have a thickness of 0.010 to 0.040 inches. Preferably, the wood is a hardwood having substantially straight grains. Even more preferably, the wood is poplar.

In various exemplary embodiments, dyeing the pretreated sheet of wick material includes dyeing the pretreated sheet of wick material, while applying heat and pressure. Any suitable dye may be used. Preferably the dye is an acid dye. Exemplary acid dyes include Acid Black 1, Acid Black 2, Acid Black 24, Acid Black 29, Acid Black 29, Acid Black 172, Acid Blue, Acid Blue 7, Acid Blue 25, Acid Blue 40, Acid Blue 62, Acid Blue 80, Acid Blue 83, Acid Blue 90, Acid Blue 92, Acid Blue 93, Acid Blue 113, Acid Blue 120, Acid Blue 127, Acid Blue 129, Acid Blue 142, Acid Green 16, Acid Green 25, Acid Green 50, Acid Orange 3, Acid Orange 7, Acid Orange 33, Acid Red 1, Acid Red 14, Acid Red 18, Acid Red 35, Acid Red 52, Acid Red 73, Acid Red 87, Acid Red 88, Acid Red 111, Acid Red 138, Acid Red 249, Acid Red 374, Acid Violet 1, Acid Violet 7, Acid Violet 17, Acid Violet 49, Acid Violet 54, Acid Yellow 11, Acid Yellow 17, Acid Yellow 36, Acid Yellow 36, Acid Yellow 44, Acid Yellow 76, and Acid Yellow 117. The dyes/colors may be used separately or in combination. The dyes may, particularly, be mixed to obtain colors in the colored planar wick including, but not limited to, apricot, aquamarine, blush, crimson, eggplant, forest, midnight, mustard, olive, peacock, arctic white, crimson red, cobalt blue, daffodil yellow, raven black, opal white, and forest green. The dyes may be mixed in any particular proportion, e.g., by mass. For example, any two, three, four, or five of the above dyes may be mixed in amounts of 1 to 100 parts by mass of one dye relative 1 to 100 parts by mass of the other one, two, three, for four dyes, including all subranges in part and tenths of a part by mass. Preferably, dyes will be selected that do not raise environmental or safety issues.

In various exemplary embodiments, dyeing the pretreated sheet of wick material includes dyeing the pretreated sheet of wick material with an aqueous solution of a powdered dye, while applying heat and pressure, until dye has penetrated through an entirety of a thickness of the wick material.

In various exemplary embodiments, pressing the dyed sheet of wick material includes applying hot pressing and cold pressing. Preferably pressing the dyed sheet of wick material includes applying hot pressing and cold pressing until the sheet of wick material has a desired moisture content-any moisture content described herein may be selected. More preferably, pressing the dyed sheet of wick material includes applying hot pressing and cold pressing until the sheet of wick material is substantially flat.

In various exemplary embodiments, cutting the pressed sheet of wick material to obtain the colored planar wick includes laser cutting the wick material to form at least one wick. Preferably, the wick has a truly planar shape, a height of the wick is 1 to 8 inches, a width of the wick is 0.25 to 6 inches, and a thickness of the wick is 0.010 to 0.040 inches. Preferably, the wick has a thickness of about 0.020 inches.

In various exemplary embodiments, laser cutting the wick material further includes cutting or engraving alphanumeric or symbolic shapes onto a surface of the wick material. In further embodiments, laser cutting the wick material further includes cutting or engraving a functional shape onto a surface of the wick material.

Processes for preparing a colored planar wick according to the present disclosure, further include applying a bend or curve to the wick after cutting. In embodiments, the bent or curved wick has an S-shape when viewed from above.

In various exemplary embodiments, cutting the pressed sheet of wick material to obtain the colored planar wick includes: laser cutting the wick material to form at least a first wick component and a second wick component; and attaching the first wick component to the second wick component to form the wick. Attaching the first wick component to the second wick component may include mechanically attaching the first wick component to the second wick component to form a wick having an X-shape or +-shape when viewed from above. In embodiments, the first wick component is a booster having a smaller width than the second wick component; and attaching the first wick component to the second wick component includes adhering the first wick component to a surface of the second wick component. In further embodiments, the first wick component has the same height and width as the second wick component; and attaching the first wick component to the second wick component includes adhering the first wick component to a surface of the second wick component to form a two-ply wick. Boosters and second plies may have any height, width, and/or thickness described herein.

While, as noted above, processes for preparing a colored planar wick according to the present disclosure may include: pretreating a sheet of wick material; dyeing the pretreated sheet of wick material; pressing the dyed sheet of wick material; and cutting the pressed sheet of wick material to obtain the colored planar wick. In alternative embodiments, the wick material may be cut into wick prior to completion of any of the above enumerated steps-that is, forming the final wick shape need not be the final step of the process. Also, processes according to the present disclosure may include merely cutting a sheet of dyed wick material to obtain the colored planar wick. In such embodiments, the sheet of dyed wick material may be obtained by a process as described herein or any other suitable process.

In various exemplary embodiments, colored planar wicks according to the present disclosure may be obtained by a process as described above. Further, in various exemplary embodiments, candles according to the present disclosure may include colored planar wicks as described herein, and a body of meltable fuel.

While the present disclosure emphasizes colored planar wicks, it is explicitly envisioned that the processes described herein may be applied to obtain colored versions of more traditional wicks. As described above, colored planar wicks can be formed from fibers that are pressed into sheets-strictly/planar sheets and/or bent/curved sheets. Such fibers may alternatively be formed into non-planar wick shapes by, e.g., braiding or weaving (as distinguished from the planar wicks otherwise described herein). Suitable non-planar wick shapes include the shape of a traditional braided wick. Any suitable fiber may be used, including all fiber types described herein, with cotton and hemp fibers being particularly preferred. The fibers are typically braided or weaved into a substantially cylindrical shape, although more oblong or substantially planar shapes are possible. Exemplary wick diameters are up to 0.005 inches, 0.005 inches, 0.010 inches, 0.020 inches, 0.030 inches, 0.040 inches, 0.050 inches, 0.060 inches, 0.070 inches, 0.080 inches, 0.090 inches, 0.1 inches, 0.2 inches, 0.3 inches, 0.4 inches, 0.4 inches or more, and all subranges in hundredths and thousandths of an inch therein. Non-planar wicks may be cut to any candle height, including those described above. The wick materials or constituent fibers may be subjected to mordanting to impart flame resistance. A braided or woven wick may optionally be provided with structural support or a core. Exemplary structural supports or cores include copper core, zinc core, paper core, cotton core, and paper filaments. The foregoing wicks may be combined with any meltable fuel or container described herein to obtain a candle.

Thus, in embodiments, colored versions of the above-described non-planar, e.g., braided or woven, wicks are obtained by processes according to the present disclosure including pretreating a piece or composition of wick material, dyeing the pretreated piece or composition of wick material, pressing the dyed piece or composition of wick material, and cutting the pressed piece or composition of wick material to obtain the colored non-planar wick. Rather than using a sheet of wick material to obtain a colored planar wick, the above steps and described variants are applied to a piece or composition of wick material and/or precursor fibers thereof. The process may be practiced to obtain a colored non-planar wick and, particularly, a colored braided or woven wick.

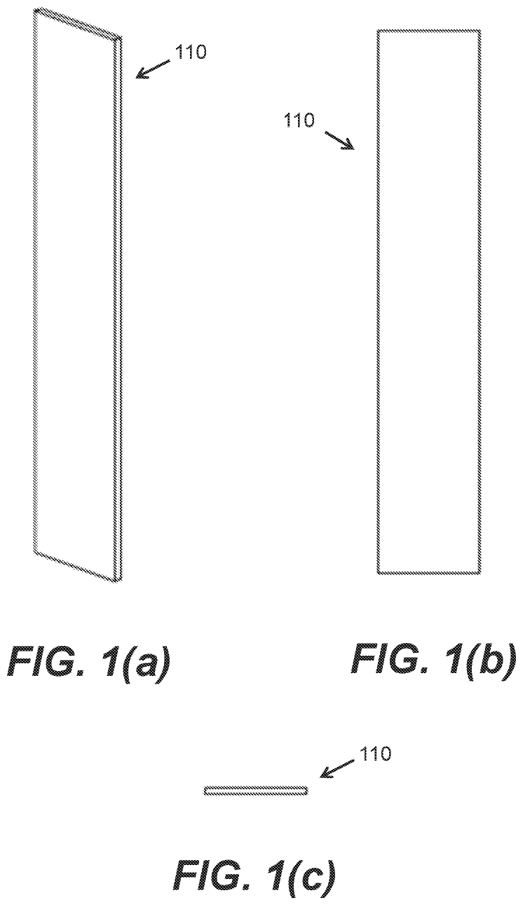

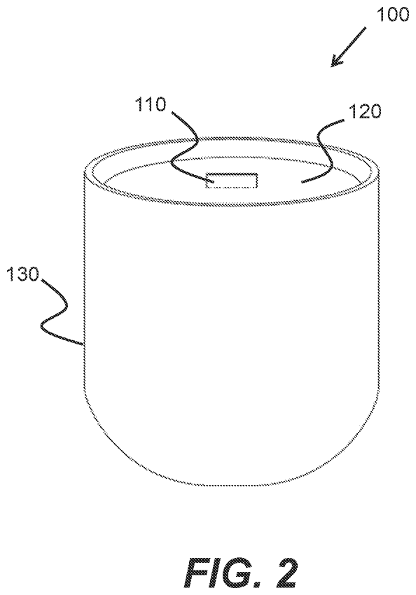

In one exemplary embodiment, the colored planar wick according to the present disclosure is a strictly or truly planar wick as shown in FIGS. 1(a), 1(b), 1(c), and 2. As shown in FIGS. 1(a) to 1(c), a wick 110 is formed of a planar material. The wick 110 is relatively thin when viewed from the side or top and thicker when viewed from the front. As shown in FIG. 2, when provided in a candle 100, a top portion of the wick 110 extends above a top surface of a meltable fuel 120, which is provided in a container 130.

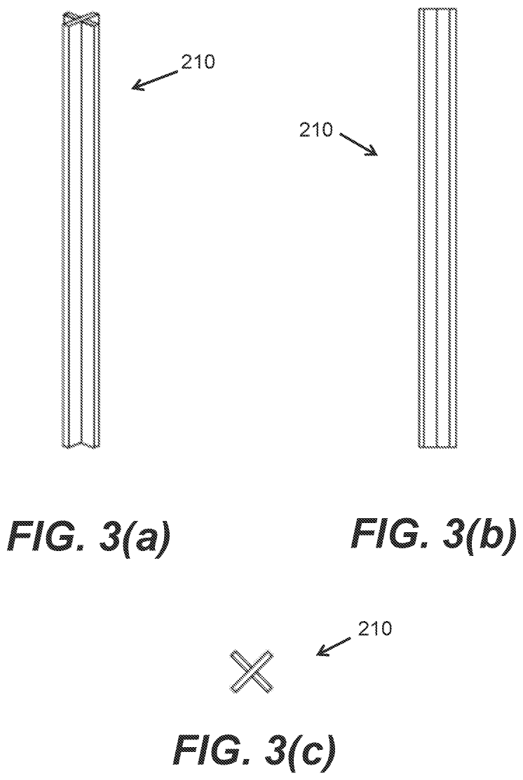

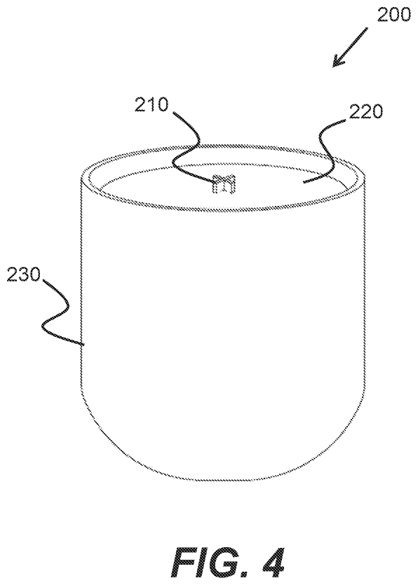

In a further exemplary embodiment, the colored planar wick according to the present disclosure is an “X”-shaped wick or “+”-shaped wick formed from a composite of multiple planar members as shown in FIGS. 3(a), 3(b), 3(c), and 4. As shown in FIGS. 3(a) to 3(c), a wick 210 is formed of two planar members fitted together to form an “X” shape or “+” shape when viewed from above. As shown in FIG. 4, when provided in a candle 200, a top portion of the wick 210 extends above a top surface of a meltable fuel 220, which is provided in a container 230.

In various exemplary embodiments, a candle may include a colored planar wick held upright by a sustainer. In preferred embodiments, the meltable fuel includes a soy wax. In further preferred embodiments, the body of meltable fuel is provided in a container.

In various exemplary embodiments, colored planar wicks according to the present disclosure are not limited to any particular process of producing and, instead, are defined their improved performance. For example, a colored planar wick may include a planar member comprising a wick material; and a dye impregnated into the wick material. The dye may present through an entirety of a thickness of the wick material. The wick may exhibit an improved burning parameter relative to an undyed wick formed of the same material and having the same dimensions, when the wick and the undyed wick are evaluated by burning in candles having identical structure and composition. The improved burning parameter is at least one selected from the group consisting of higher burning temperature, higher flame height, greater wax pool growth, and reduced acoustic crackling. Such wicks may have any combination of components and structural and compositional features described herein. Such wicks may further be provided in candles having any combination of components and structural and compositional features described herein.

Notably, it has been discovered that colored planar wicks as described herein burn hotter than undyed wicks when controlling for vessel, wax, and wick size. Taller flame heights and wider wax pools were measured over like time periods. Further, on a scale of 1-5 of observed acoustic crackling, colored planar wicks as described herein will often achieve 1-2 rating-compared to an observed acoustic crackling of 3-4 for a like undyed wick. This reduction in sound is desirable in certain applications. Further, colored planar wicks as described herein, when provided at lower thicknesses (e.g., 0.020 inches) can be effectively used in soy wax candles. Undyed wicks of like thickness typically require meltable fuels with a higher petroleum content for effective use.

In various exemplary embodiments, the present disclosure relates the following items and all combinations thereof:
1. A colored wick, comprising:
a sheet comprising at least one selected from the group consisting of wood, a wood-like substance, and cellulose fiber;
wherein:
the sheet is treated with a dye or color pigment;
the sheet is laser cut to form interlocking sheets; and
the colored wick comprises at least two interlocking sheets assembled together to form an X-shape or +-shape when viewed from above when provided in a candle.
2. The colored wick of item 1 or any item depending therefrom, wherein:
a height of the wick is 1 to 8 inches;
a width of the wick is 0.125 to 6 inches; and
a thickness of the wick is 0.010 to 0.040 inches.
3. The colored wick of item 1 or any item depending therefrom, wherein the sheet comprises a hardwood having substantially straight grains.
4. A candle, comprising:
a colored wick; and
a body of meltable fuel;
wherein:
the colored wick comprises a sheet comprising at least one selected from the group consisting of wood, a wood-like substance, and cellulose fiber;
the sheet is treated with a dye or color pigment;
the sheet is treated with at least one selected from the group consisting of hot pressure and cold pressure;
the sheet is laser cut to form interlocking sheets; and
the sheet is laser cut into at least two interlocking sheets assembled together to form an X-shape or +-shape when viewed from above.
5. The candle of item 4 or any item depending therefrom, wherein:
a height of the wick is 1 to 8 inches;
a width of the wick is 0.125 to 6 inches; and
a thickness of the wick is 0.010 to 0.040 inches.
6. The candle of item 4 or any item depending therefrom, wherein the sheet comprises a hardwood having substantially straight grains.
7 A colored wick, comprising:
a sheet comprising at least one selected from the group consisting of wood, a wood-like substance, and cellulose fiber;
wherein:
the sheet is treated with a dye or color pigment;
the sheet is laser cut; and
the sheet is shaped to have an S-shape, a curve, or a round shape when viewed from above when provided in a candle.
8. The colored wick of item 7 or any item depending therefrom, wherein:
a height of the wick is 1 to 8 inches;
a width of the wick is 0.125 to 6 inches; and
a thickness of the wick is 0.010 to 0.040 inches.
9. The colored wick of item 7 or any item depending therefrom, wherein the sheet comprises a hardwood having substantially straight grains.
10. A candle, comprising:
a colored wick; and
a body of meltable fuel;
wherein:
the colored wick comprises a sheet comprising at least one selected from the group consisting of wood, a wood-like substance, and cellulose fiber;
the sheet is treated with a dye or color pigment;
the sheet is treated with at least one selected from the group consisting of hot pressure and cold pressure; and
the sheet is laser cut and shaped to have an S-shape, a curve, or a round shape when viewed from above.
11. The candle of item 10 or any item depending therefrom, wherein:
a height of the wick is 1 to 8 inches;
a width of the wick is 0.125 to 6 inches; and
a thickness of the wick is 0.010 to 0.040 inches.
12. The candle of item 10 or any item depending therefrom, wherein the sheet comprises a hardwood having substantially straight grains.
13. A process for preparing a colored planar wick, comprising:
pretreating a sheet of wick material;
dyeing the pretreated sheet of wick material;
pressing the dyed sheet of wick material; and cutting the pressed sheet of wick material to obtain the colored planar wick.
14. The process of item 13 or any item depending therefrom, further comprising drying the dyed sheet of wick material before pressing.
15. The process of item 13 or any item depending therefrom, wherein pretreating the sheet of wick material comprises bleaching the sheet of wick material.
16. The process of item 13 or any item depending therefrom, wherein the sheet of wick material comprises a sheet of wood.
17. The process of item 16 or any item depending therefrom, wherein the sheet of wick material has a thickness of 0.010 to 0.040 inches.
18. The process of item 16 or any item depending therefrom, wherein the wood is a hardwood having substantially straight grains.
19. The process of item 18 or any item depending therefrom, wherein the wood is poplar.
20. The process of item 13 or any item depending therefrom, wherein dyeing the pretreated sheet of wick material comprises dyeing the pretreated sheet of wick material with an aqueous solution of a powdered dye, while applying heat and pressure.
21. The process of item 20 or any item depending therefrom, wherein dyeing the pretreated sheet of wick material comprises dyeing with at least one acid dye.
22. The process of item 20 or any item depending therefrom, wherein dyeing the pretreated sheet of wick material comprises dyeing the pretreated sheet of wick material with an aqueous solution of a powdered dye, while applying heat and pressure, until dye has penetrated through an entirety of a thickness of the wick material.
23. The process of item 13 or any item depending therefrom, wherein pressing the dyed sheet of wick material comprises applying hot pressing and cold pressing.
24. The process of item 13 or any item depending therefrom, wherein cutting the pressed sheet of wick material to obtain the colored planar wick comprises laser cutting the wick material to form at least one wick, wherein:
the wick has a truly planar shape;
a height of the wick is 1 to 8 inches;
a width of the wick is 0.125 to 6 inches; and
a thickness of the wick is 0.010 to 0.040 inches.
25. The process of item 24 or any item depending therefrom, wherein the wick has a thickness of about 0.020 inches.
26. The process of item 24 or any item depending therefrom, wherein laser cutting the wick material further comprises cutting or engraving alphanumeric or symbolic shapes onto a surface of the wick material.
27. The process of item 24 or any item depending therefrom, wherein laser cutting the wick material further comprises cutting or engraving a functional shape onto a surface of the wick material.
28. The process of item 24 or any item depending therefrom, further comprising applying a bend or curve to the wick.
29. The process of item 28 or any item depending therefrom, wherein the bent or curved wick as an S-shape when viewed from above.
30. The process of item 13 or any item depending therefrom, wherein cutting the pressed sheet of wick material to obtain the colored planar wick comprises:
laser cutting the wick material to form at least a first wick component and a second wick component; and
attaching the first wick component to the second wick component to form the wick.
31. The process of item 30 or any item depending therefrom, wherein attaching the first wick component to the second wick component comprises mechanically attaching the first wick component to the second wick component to form a wick having an X-shape or +-shape when viewed from above.
32. The process of item 30 or any item depending therefrom, wherein:
the first wick component is a booster having a smaller width than the second wick component; and
attaching the first wick component to the second wick component comprises adhering the first wick component to a surface of the second wick component.
33. The process of item 30 or any item depending therefrom, wherein:
the first wick component has the same height and width as the second wick component; and
attaching the first wick component to the second wick component comprises adhering the first wick component to a surface of the second wick component to form a two-ply wick.
34. A colored planar wick obtained by the process of item 13 or any item depending therefrom.
35. A candle, comprising:
the colored planar wick of item 34 or any item depending therefrom; and
a body of meltable fuel.
36. The candle of item 35 or any item depending therefrom, wherein the colored planar wick is held upright by a sustainer.
37. The candle of item 35 or any item depending therefrom, wherein the meltable fuel comprises a soy wax.
38. The candle of item 35 or any item depending therefrom, wherein the body of meltable fuel is provided in a container.
39. A process for preparing a colored planar wick, comprising:
cutting a sheet of dyed wick material to obtain the colored planar wick;
wherein the sheet of wick material was prepared by a process comprising:
   pretreating a sheet of wick material;
   dyeing the pretreated sheet of wick material; and
   pressing the dyed sheet of wick material.
40. A colored planar wick, comprising:
a planar member comprising a wick material; and
a dye impregnated into the wick material;
wherein:
the dye is present through an entirety of a thickness of the wick material;
the wick exhibits an improved burning parameter relative to an undyed wick formed of the same material and having the same dimensions, when the wick and the undyed wick are evaluated by burning in candles having identical structure and composition; and
the improved burning parameter is at least one selected from the group consisting of higher burning temperature, higher flame height, greater wax pool growth, and reduced acoustic crackling.
41. The colored wick of item 40 or any item depending therefrom, wherein:
the improved burning parameter is higher burning temperature; and
the wick exhibits an increase of at least 20% in burning temperature relative to the undyed wick.
42. The colored wick of item 40 or any item depending therefrom, wherein:
the improved burning parameter is higher flame height; and
the wick exhibits an increase of at least 20% in flame height relative to the undyed wick.
43. The colored wick of item 40 or any item depending therefrom, wherein:
the improved burning parameter is greater wax pool growth; and
the wick exhibits decrease of at least 20% in amount of time to reach a target wax pool width relative to the undyed wick.
44. The colored wick of item 40 or any item depending therefrom, wherein:
the improved burning parameter is reduced acoustic crackling; and
the wick exhibits a reduction of at least 20% in in acoustic crackling relative to the undyed wick.
45. The colored planar wick of item 40 or any item depending therefrom, wherein the planar member comprises wood.
46. The colored planar wick of item 45 or any item depending therefrom, wherein the wood is a hardwood having substantially straight grains.
47. The colored planar wick of item 46 or any item depending therefrom, wherein the wood is poplar.
48. The colored planar wick of item 40 or any item depending therefrom, wherein the dye comprises at least one acid dye.
49. The colored planar wick of item 40 or any item depending therefrom, wherein:
the wick has a truly planar shape;
a height of the wick is 1 to 8 inches;
a width of the wick is 0.125 to 6 inches; and
a thickness of the wick is 0.010 to 0.040 inches.
50. The colored planar wick of item 49 or any item depending therefrom, wherein the wick has a thickness of about 0.020 inches.
51. The colored planar wick of item 49 or any item depending therefrom, wherein the wick comprises an alphanumeric or symbolic shape cut or engraved onto a surface thereof.
52. The colored planar wick of item 49 or any item depending therefrom, wherein the wick comprises a functional shape cut or engraved onto a surface thereof.
53. The colored planar wick of item 49 or any item depending therefrom, wherein the planar member has a bend or curve when viewed from above.
54. The colored planar wick of item 49 or any item depending therefrom, wherein the planar member has an S-shape when viewed from above.
55. The colored planar wick of item 40 or any item depending therefrom, wherein the planar member comprises a first planar component and a second planar component which together have an X-shape or +-shape when viewed from above.
56. The colored planar wick of item 40 or any item depending therefrom, wherein:
the planar member comprises a first planar component and a second planar component;
the first planar component is a booster having a smaller width than the second planar component; and
the first planar component is adhered to the second planar component.
57. The colored planar wick of item 40 or any item depending therefrom, wherein:
the planar member comprises a first planar component and a second planar component;
the first planar component has the same height and width as the second planar component; and
the first planar component is adhered to the second planar component to form a two-ply wick.
58. A candle, comprising:
the colored planar wick of item 40 or any item depending therefrom; and
a body of meltable fuel.
59. The candle of item 58 or any item depending therefrom, wherein the colored planar wick is held upright by a sustainer.
60. The candle of item 58 or any item depending therefrom, wherein the meltable fuel comprises a soy wax.
61. The candle of item 58 or any item depending therefrom, wherein the body of meltable fuel is provided in a container.

### EXAMPLES

Some of the foregoing improvements were confirmed in the following examples. Several colored planar wicks according to the present disclosure were compared to like undyed wicks to ascertain differences in performance. Inventive colored planar wicks were prepared by a process as described herein. Comparative wicks were prepared by laser cutting untreated, undyed veneer to obtain wicks and wick components.

In a first experiment, the inventive and comparative wicks were formed of a single rectangular ply of poplar having a height of 3 inches, a width of 0.5 inches, and a thickness of 0.020 inches. The inventive wicks included samples dyed in a variety of colors shown in TABLE A below. Each wick was provided in an identical candle including a coco apricot wax meltable fuel and a cylindrical container having a height of 3.5 inches and a diameter of 3 inches. Each candle was lit, flame height was measured immediately after the candle was lit and then hourly until a four-hour burning period was completed. The evaluation was performed using multiple candles and burn cycles, and the average of the measured values was determined. The candles were also observed during the four-hour burning period to determine the (average) time necessary for the melt pool to reach the full diameter of the container (melt pool marker). The results are shown in TABLE A below.

TABLE A

| Single Ply Wick | Flame Height | Melt Pool Marker |
|---|---|---|
| Apricot | 0.289″ | 2-3 hours |
| Aquamarine | 2.73″ | 2-3 hours |
| Blush | 2.65″ | 2-3 hours |
| Crimson | 2.48″ | 2-3 hours |
| Eggplant | 2.63″ | 2-3 hours |
| Forest | 2.59″ | 2-3 hours |
| Midnight | 2.63″ | 2-3 hours |
| Mustard | 2.60″ | 2-3 hours |
| Olive | 2.69″ | 2-3 hours |
| Peacock | 2.59″ | 2-3 hours |
| Arctic White | 2.5″ | 2-3 hours |
| Undyed | .625″ | within 4 hours |

In a second experiment, the inventive and comparative wicks were formed as X-shaped wicks by connecting two rectangular plies of poplar having a height of 3 inches, a width of 0.5 inches, and a thickness of 0.020 inches, each ply being laser cut for interlocking. The inventive wicks included samples dyed in a variety of colors shown in the TABLE B below. Each wick was provided in an identical candle including a virgin coco soy wax meltable fuel and a cylindrical container having a height of 3.5 inches and a diameter of 3 inches. Each candle was lit, flame height was measured immediately after the candle was lit and then hourly until a four-hour burning period was completed. The evaluation was performed using multiple candles and burn cycles, and the average of the measured values was determined. The candles were also observed during the four-hour burning period to determine the (average) time necessary for the melt pool to reach the full diameter of the container (melt pool marker). The results are shown in the TABLE B below.

TABLE B

| X-Shaped Wick | Flame Height | Melt Pool Marker |
|---|---|---|
| Apricot | 1.208″ | 1-2 hours |
| Aquamarine | 2.676″ | 1-2 hours |
| Blush | 2.607″ | 1-2 hours |
| Crimson | 2.818″ | 1-2 hours |
| Eggplant | 2.767″ | 1-2 hours |
| Forest | 2.88″ | 1-2 hours |
| Midnight | 3.00″ | 1-2 hours |
| Mustard | 2.723″ | 1-2 hours |
| Olive | 2.706″ | 1-2 hours |
| Peacock | 2.72″ | 1-2 hours |
| Arctic White | 1.56″ | 1-2 hours |
| Undyed | 1″ | 2 hours |

As can be seen from TABLE A and TABLE B above, preparing colored planar wicks by the processes described herein results in a significant improvement in flame height and a significant reduction in the amount of time needed to reach a desired melt pool width. These improvements in performance are commercially significant and entirely unexpected.

Without being limited to any particular theory, it is believed that processing steps, including particularly a bleaching pretreatment and drying, “clean out” wood cells an allow molten fuel to more efficiently travel through the colored planar wick. Further, the improvement is consistent. That is, not only are higher burning temperature, higher flame height, greater wax pool growth, and reduced acoustic crackling achieved, but they are achieved consistently. That is, the desirable properties are present throughout the life of the candle-such consistency is not found in undyed wicks.

In various exemplary embodiments, the improved burning parameter is higher burning temperature; and the wick exhibits an increase of at least 20% in burning temperature relative to the undyed wick. Burning temperature can be measured using any suitable apparatus to measure the temperature of a flame obtained when a colored planar wick is burned in a candle. Burning temperature might also be evaluated with reference to temperature of the wax or container of the candle. The degree of improvement is measured by comparing the burning temperature of the colored planar wick to the burning temperature of an undyed wick that is identical in size and shape, when burned in an identical candle—i.e., identical meltable fuel and container of identical size and shape. The meltable fuel and container size and shape may be any selected from the description herein. The comparison is desirably measured in percent. For example, if the undyed wick burned at 1,000° C. and the colored planar wick burned at 1,100° C., this would represent a 10% increase in burning temperature. In various exemplary embodiments, the colored planar wicks of the present disclosure exhibit an increased burning temperature of at least 1%, at least 5%, at least 10%, at least 20%, at least 30%, at least 40%, at least 50%, and all subranges therein in tenths and hundredths of a percent and percent.

In various exemplary embodiments, the improved burning parameter is higher flame height; and the wick exhibits an increase of at least 20% in flame height relative to the undyed wick. Flame height can be measured using any suitable apparatus to measure the height of the flame obtained when a colored planar wick is burned in a candle. Desirably, flame height is an average of flame heights measured immediately after a candle is lit and then hourly until a four-hour burning period is completed. The degree of improvement is measured by comparing the average flame height of the colored planar wick to the average flame height of an undyed wick that is identical in size and shape, when burned in an identical candle—i.e., identical meltable fuel and container of identical size and shape. The meltable fuel and container size and shape may be any selected from the description herein. The comparison is desirably measured in percent. For example, if the undyed wick burned with an average flame height of 1 inch and the colored planar wick burned with an average flame height of 1.5 inches, this would represent a 50% increase in flame height. In various exemplary embodiments, the colored planar wicks of the present disclosure exhibit an increased flame height of at least 20%, at least 50%, at least 100%, at least 150%, at least 200%, at least 250%, at least 300% and all subranges therein in percent and tens of percent.

In various exemplary embodiments, the improved burning parameter is greater wax pool growth; and the wick exhibits an decrease of at least 20% in the amount of time required to reach a target wax pool width relative to the undyed wick. Wax pool growth can be evaluated by measuring the time needed to reach the target wax pool width when a colored planar wick is burned in a candle, beginning when the candle is lit. Desirably, the target wax pool width is the full diameter of the container of the candle. The degree of improvement is measured by comparing the time required to achieve target wax pool width for the colored planar wick to the time for an undyed wick that is identical in size and shape, when burned in an identical candle—i.e., identical meltable fuel and container of identical size and shape. The meltable fuel and container size and shape may be any selected from the description herein. The comparison is desirably measured in percent. For example, if the undyed wick required 2 hours to reach the target wax pool width and the colored planar wick required 1.5 hours, this would represent a 25% decrease in time. In various exemplary embodiments, the colored planar wicks of the present disclosure exhibit a decrease in time required to reach a target wax pool width of at least 10%, at least 20%, at least 25%, at least 30%, at least 40%, at least 50%, and all subranges therein in percent. The time required to achieve a wax pool width of the full diameter of the container of the candle is desirably within a four hour burning cycle, even more desirably within two to three hours, and preferably within two hours.

In various exemplary embodiments, the improved burning parameter is reduced acoustic crackling; and the wick exhibits a reduction of at least 20% in in acoustic crackling relative to the undyed wick. Acoustic crackling is measured by observation of a skilled artisan. A skilled artisan listens when a colored planar wick is burned in a candle and compares the sound with that obtained when other wick/candle combinations are burned. Acoustic crackling is measured on a scale of 1 to 5 with undyed maple and birch giving a crackling sound that ranges between 1 and 3, cherry wood giving a crackling sound that ranges between 3 and 5, and poplar giving a crackling sound that ranges between 3 and 4. The degree of improvement is measured by comparing the acoustic crackling value of the colored planar wick to the acoustic crackling value of an undyed wick that is identical in size and shape, when burned in an identical candle—i.e., identical meltable fuel and container of identical size and shape. The meltable fuel and container size and shape may be any selected from the description herein. The comparison is desirably measured in percent. For example, if the undyed wick exhibited an acoustic crackling value of 4 and the colored planar wick exhibited the acoustic crackling value of 3, this would represent a 25% decrease in acoustic crackling. In various exemplary embodiments, the colored planar wicks of the present disclosure exhibit a decrease in acoustic crackling of at least 10%, at least 15%, at least 20%, at least 25%, at least 30%, at least 35%, at least 40%, at least 45%, at least 50% and all subranges therein in percent.

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present invention is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1: A colored wick, comprising:
a sheet comprising at least one selected from the group consisting of wood, a wood-like substance, and cellulose fiber;
wherein:
the sheet is treated with a dye or color pigment;
the sheet is laser cut to form interlocking sheets; and
the colored wick comprises at least two interlocking sheets assembled together to form an X-shape or +-shape when viewed from above when provided in a candle.

2: The colored wick of claim 1, wherein:
a height of the wick is 1 to 8 inches;
a width of the wick is 0.125 to 6 inches; and
a thickness of the wick is 0.010 to 0.040 inches.

3: The colored wick of claim 1, wherein the sheet comprises a hardwood having substantially straight grains.

4: A candle, comprising:
the colored wick according to claim 1; and
a body of meltable fuel.

5: The candle of claim 4, wherein:
a height of the wick is 1 to 8 inches;
a width of the wick is 0.125 to 6 inches; and
a thickness of the wick is 0.010 to 0.040 inches.

6: The candle of claim 4, wherein the sheet comprises a hardwood having substantially straight grains.

7-12. (canceled)

13: A process for preparing a colored planar wick, comprising:
pretreating a sheet of wick material;
dyeing the pretreated sheet of wick material;
pressing the dyed sheet of wick material; and
cutting the pressed sheet of wick material to obtain the colored planar wick.

14: The process of claim 13, further comprising drying the dyed sheet of wick material before pressing.

15: The process of claim 13, wherein pretreating the sheet of wick material comprises bleaching the sheet of wick material.

16: The process of claim 13, wherein the sheet of wick material comprises a sheet of wood.

17: The process of claim 16, wherein the sheet of wick material has a thickness of 0.010 to 0.040 inches.

18: The process of claim 16, wherein the wood is a hardwood having substantially straight grains.

19: The process of claim 18, wherein the wood is poplar.

20-39. (canceled)

40: A colored planar wick, comprising:
a planar member comprising a wick material; and
a dye impregnated into the wick material;
wherein:
the dye is present through an entirety of a thickness of the wick material; the wick exhibits an improved burning parameter relative to an undyed wick formed of the same material and having the same dimensions, when the wick and the undyed wick are evaluated by burning in candles having identical structure and composition; and
the improved burning parameter is at least one selected from the group consisting of higher burning temperature, higher flame height, greater wax pool growth, and reduced acoustic crackling.

41: The colored wick of claim 40, wherein:
the improved burning parameter is higher burning temperature; and
the wick exhibits an increase of at least 20% in burning temperature relative to the undyed wick.

42: The colored wick of claim 40, wherein:
the improved burning parameter is higher flame height; and
the wick exhibits an increase of at least 20% in flame height relative to the undyed wick.

43: The colored wick of claim 40, wherein:
the improved burning parameter is greater wax pool growth; and
the wick exhibits decrease of at least 20% in amount of time to reach a target wax pool width relative to the undyed wick.

44: The colored wick of claim 40, wherein:
the improved burning parameter is reduced acoustic crackling; and
the wick exhibits a reduction of at least 20% in in acoustic crackling relative to the undyed wick.

45: The colored planar wick of claim 40, wherein the planar member comprises wood.

46: The colored planar wick of claim 45, wherein the wood is a hardwood having substantially straight grains.

47-61. (canceled)
